(19) United States
(12) Patent Application Publication
(10) Pub. No.: US 2009/0154916 A1
(43) Pub. Date: Jun. 18, 2009

(54) Method and Apparatus for GPON GEM Error Correction Implementation

(75) Inventors: Shuo Huang, Novato, CA (US); Paul E. O'Connor, Grass Valley, CA (US)

Correspondence Address: James M. Wu;JW Law Group, 84 W. Santa Clara Street, Suite 820, San Jose, CA, 95113, US

(73) Assignee: Tellabs Petaluma, Inc., Naperville, IL (US)

(21) Appl. No.: 11/955,208

(22) Filed: Dec. 12, 2007

(51) Int. Cl. H04B 10/00

(52) U.S. Cl. 398/1

(57) ABSTRACT

A method and a device of enhancing data integrity using hash function for data transmission over an optical network are disclosed. The device includes a hash circuit, a lookup circuit, a vector circuit, and a correcting circuit. The hash circuit is capable of performing a hash function and configured to generate a hash value in response to a value of header error correction (“HEC”) encapsulated in a gigabit passive optical network (“GPON”) frame. The lookup circuit is capable of obtaining a data entry from a lookup table in a memory in accordance with the hash value. While the vector circuit generates an error vector in response to the data entry, the correcting circuit corrects an error or errors in the header portion of a data structure encapsulated in the GPON frame.

### FIELD

The exemplary embodiment(s) of the present invention relates to optical communications network. More specifically, the exemplary embodiment(s) of the present invention relates to improving data integrity during data transmission in an optical communications network.

### BACKGROUND

With increasing demand for more information to be supplied to homes and/or businesses, many network communication providers are switching or upgrading their networks to optical communications networks. Optical communications networks typically offer high speed audio, video, and data transmission to/from homes and/or businesses. Typical example of optical network architecture may be fiber to the x (“FTTX”), which includes fiber to the node/neighborhood (“FTTN”), fiber to the curb (“FTTC”), fiber to the building (“FTTB”), fiber to the home (“FTTH”) or other edge location to which a fiber network extends.

To transmit an optical signal from a source to a destination over an optical communications network such as passive optical network (“PON”), the signal typically travels through multiple optical components, such as an optical network terminal (“ONT”), an optical distribution network (“ODN”), an optical line termination (“OLT”), and the like. Each of the optical components may occasionally malfunction in such a way that the upstream or downstream signal has too low a signal-to-noise ratio (“SNR”). Low SNR and/or malfunctioning optical components, for example, typically cause bit errors during packets transmission.

Data packets are typically employed in upstream and/or downstream between optical components. A typical data packet, for example, includes a packet header and a packet payload, wherein the packet header is typically in a fixed length while the packet payload is in a variable length. The packet header is usually used to indicate the length of the packet payload. As such, when packet header is properly read, the optical component can determine the packet boundary between consecutive packets in a steam based on the information contained in the packet header.

Optical components can typically identify each individual packet in a data stream as long as no bit error(s) in the packet header. If, however, the bits in a packet header are corrupted during the transmission, the packet boundary may be moved or lost. As such, misalignment between packets in a stream may occur when packet header is corrupted. For example, if the indicator for payload length, which indirectly points to the end of the packet, is corrupted, the boundary between the continuous packets becomes undetermined. Re-synchronizing or realigning the packets to recover the packet boundary within a data stream takes time and resources. Therefore, the occurrence of bit error or errors during a transmission, especially in the packet header, causes packets to misalign, which negatively affects system performance.

### SUMMARY

A method and apparatus for enhancing the data integrity using a hash lookup device during data transmission via an optical communications network are described. The device includes a hash circuit, a lookup circuit, a vector circuit, and a correcting circuit. The hash circuit is capable of performing a hash function and generating a hash value in response to a value of header error correction (“HEC”) encapsulated in a gigabit passive optical network (“GPON”) frame. The lookup circuit is capable of obtaining a data entry from a lookup table in a memory in accordance with the hash value. While the vector circuit generates an error vector in response to the data entry, the correcting circuit corrects an error or errors in the header portion of a data structure encapsulated in the GPON frame.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a gigabit passive optical network encapsulation method (“GEM”) data structure in accordance with one embodiment of the present invention;

FIG. 2 is a block diagram illustrating a hash lookup decoder configured to enhance data integrity in accordance with one embodiment of the present invention;

FIG. 3 illustrates an example of using a hash lookup device in accordance with one embodiment of the present invention; and

FIG. 4 is a flowchart illustrating an error correcting process using a hash function to enhance data integrity in accordance with one embodiment of the present invention.

### DETAILED DESCRIPTION

Exemplary embodiment(s) of the present invention is described herein in the context of a method, system and apparatus of enhancing data integrity using a hash lookup device for data transmission via an optical communications network.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skilled in the art having the benefit of this disclosure.

A mechanism for enhancing data integrity using a hash lookup for data transmission via an optical communications network is described. The device includes a hash circuit, a lookup circuit, a vector circuit, and a correcting circuit. The hash circuit is capable of performing a hash function and generating a hash value in response to a syndrome computed from a received data block including header error correction (“HEC”) code encapsulated in a gigabit passive optical network (“GPON”) frame. The lookup circuit is capable of obtaining a data entry or subentry from a lookup table in a memory in accordance with the hash value. While the vector circuit generates an error vector in response to the data entry, the correcting circuit corrects an error or errors in a header portion of a data structure encapsulated in the GPON frame.

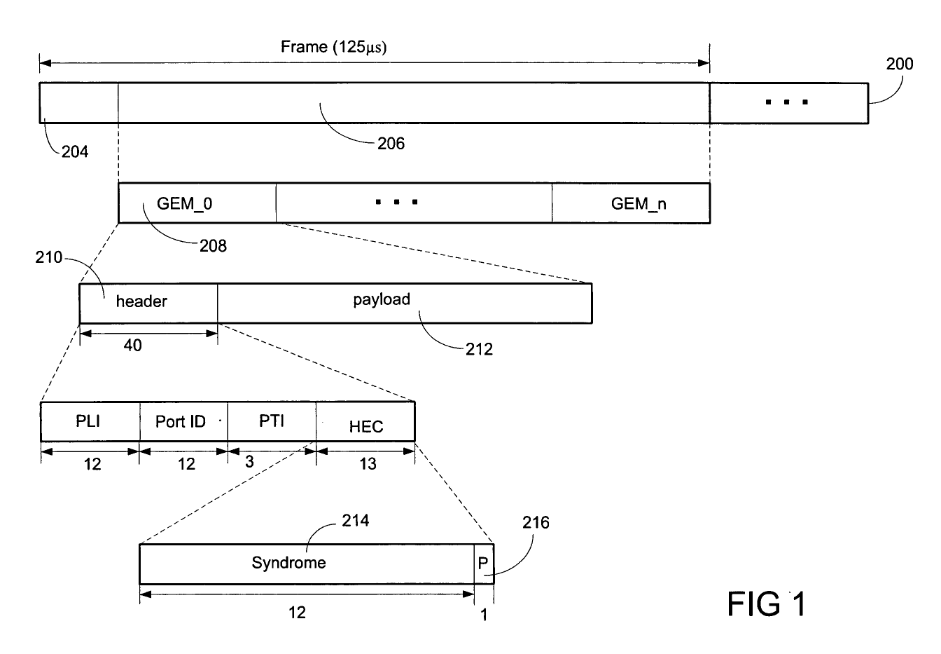

FIG. 1 is a block diagram illustrating a gigabit passive optical network encapsulation method (“GEM”) data stream 200 in accordance with one embodiment of the present invention. Stream 200 illustrates a GEM data structure, which is encapsulated or embedded in a series of GPON frames. Each GPON frame includes a GPON header 204 and a GPON payload 206 wherein GPON header 204 generally includes information relating to the frame such as synchronous parameters. A payload usually includes data or user information that is transmitted by the frame. GPON Payload 206, in this embodiment, includes multiple GEMs 208, which may be arranged from GEM(0) to GEM(n). Each GEM 208 includes a header 210 and a payload 212, wherein payload 212 contains data or user information.

Each GEM header has a fixed length while each GEM payload has a variable length. For example, GEM 208 has a 40-bit length of header 210 wherein the length of payload is identified by header 210. As such, the boundary between GEMs is identified by the header. Header 210, in one embodiment, includes a 12-bit field of payload length indicator (“PLI”), a 12-bit field of port identification (“PID”), a 3-bit field of payload type indicator (“PTI”), and a 13-bit field of header error control (“HEC”). The PLI indicates the length of the payload, which may equal to the total data bytes in the payload field. The port ID indicates the destination and PTI identifies the data type in payload 212. Since the location of the next GEM 208 is determined by the header 210 of current GEM 208, it is critical to ensure the data integrity of header. The HEC, in this embodiment, is used to protect the data integrity of GEM header 210. The HEC is configured to include information indicating a single correctable error, a double correctable error, and a triple (or more) detectable error.

The HEC field includes a first correction part 214 and a second correction part 216, wherein first correction part 214 includes a 12-bit syndrome field coded in truncated Bose, Chaudhuri, and Hocquengham (“BCH”) code. The BCH generator polynomial is, for example, x¹²+x¹⁰+x⁸+x⁵+x⁴+x³+1, which can be applied to the header. Syndrome field 214 includes a unique syndrome generated by the BCH whereby the 39-bit result of the header is divisible by the generator polynomial. The syndrome in the HEC field is calculated over the head data before it is transmitted. When the head data is transmitted, a new syndrome is calculated from the received head data which may include bit error(s). A property of the recalculated syndrome is such that every single-error or every double-error has a unique 12-bit syndrome. As such, a single-bit error and/or a double-bit error are correctable through the unique syndrome created via the BCH.

The second correction part of HEC is a single parity bit 216, which is used to set the total number of ones in the header field to an even number. It should be noted that syndrome values of some two-bit errors are the same as those of three bit errors. Parity bit 216, in one embodiment, is used to indicate whether the header has a two-bit correctable error or a three-bit detectable error. For example, if the syndrome indicates a two-bit error and there is no parity violation, header 210 has a two-bit correctable error. If, on the other hand, the syndrome indicates a two-bit error and there is parity violation, header 210 contains three bit errors. Parity bit 216 is used to determine whether header 210 has a two-bit correctable error or a three-bit detectable error.

In operation, when a GEM is received, a syndrome can be computed in accordance with the information contained in the header. If the syndrome is zero, the received header contains no error(s). If, however, the syndrome is nonzero, the received header contains at least one error. When an error is detected in the header, all bits in the header need to be decoded and processed. Several decoding methods, such as algorithmic decoding and lookup table decoding, may be used to decode the head data coded in BCH, which is capable of including error detection and error correction information.

Algorithmic decoding (“AD”) method decodes BCH mathematically. For example, upon receipt of polynomial header bits, a syndrome is computed in accordance with the head bits. After determining the error-location polynomial in response to the syndrome, error-location numbers β₁ and β₂ are calculated. β₁ and β₂ point first and second error locations in the header bits. The error(s) is subsequently corrected in accordance with β₁ and β₂. AD method generally requires one (1) clock cycle for each bit. For example, if a header contains 27 bits of head data, AD method may require 27 clock cycles to produce the results or identify error locations. The head data, for example, includes PLI, Port ID, and PTI. It is advantageous to use the AD method to handle a small number of bits.

Lookup table decoding (“LTD”) method uses a table to provide BCH decoding, wherein the table contains pre-calculated error-location numbers β₁ and β₂ for all possible syndromes. Upon receipt of header bits, a syndrome is computed in accordance with the head bits. The pre-calculated error-location numbers β₁ and β₂ are fetched in response to the syndrome, which may be used as the memory address. Although LTD method is relatively fast to obtain the error-location numbers, it may require large memory space if the syndrome contains many bits. For example, if the header includes a 27-bit field for head data and the syndrome has 12 bits, a total number of entries for a table is 2¹² (4096 entries). To cover a 27-bit head data, each of β₁ and β₂ requires a 5-bit field to cover every error location in a 27-bit field or word. It should be noted that with 4096 possible syndromes, the minimal table size is (10×4096) 40960 bits.

To enhance the device performance, hash lookup decoding (“HLD”) method can be used. To reduce the table size (or memory size), HLD method employs a hash function capable of generating a hash table. Upon receipt of header bits, a syndrome is computed in accordance with the head bits. A hash value, a key value, and a weigh value are subsequently calculated in accordance with the syndrome. In one embodiment, if the weight value is 0, it indicates that the header has no error, and if the weight value is 1 or 2, it indicates that bit error(s) is in the HEC of the header. On the other hand, if the weight value is greater than 2, it indicates at least one bit error(s) in the data field of the header, and the lookup table needs to be searched to identify whether the bit error(s) is correctable. With parallel processing, HLD method can provide a result of error-location numbers β₁ and β₂ more quickly than AD method. An advantage of using the HLD method is to use less memory space than LTD method.

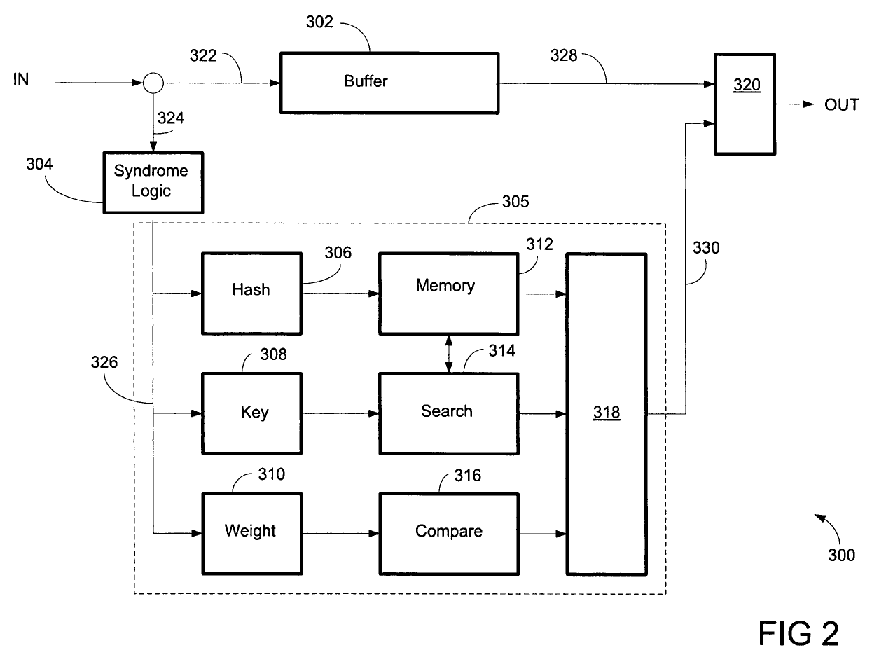

FIG. 2 is a block diagram illustrating a hash lookup decoder or device 300 configured to enhance data integrity in accordance with one embodiment of the present invention. Device 300 includes a buffer 302, a syndrome logic 304, and a hash component 305. Buffer 302 is configured to store information relating to head data, wherein the head data is referring to as PLI, port ID, and PTI. As illustrated shown in FIG. 1, header 210 may include a 12-bit field for PLI, a 12-bit field for Port ID, and a 3-bit field for PTI, buffer 302 should have at least 27 bits storage capacity to store PLI, Port ID, and PTI. It should be noted that the underlying concept of the embodiment does not change if one or more functional elements were added to or removed from device 300.

Syndrome logic 304 is configured to code and decode an error-correcting code, such as BCH, which is capable of generating a unique syndrome representing the content of header 210 if the content includes errors. Each syndrome value indicates no error, correctable error(s), or uncorrectable errors. For example, if the content of header 210 has a 39-bit field with 27 bits for the head data, syndrome logic 304 computes a unique syndrome for the 39-bit header. It should be noted that parity bit 216, as shown in FIG. 1, is not used to compute the syndrome. It should be noted that the generator polynomial for BCH (63, 12, 2) is x¹²+x¹⁰+x⁸+x⁵+x⁴+x³+1. If no bit error has occurred during the transmission, the syndrome should provide a zero result. Table 1, shown below, illustrates an example of calculating a unique syndrome from a 39-bit header 210 using BCH (63, 12, 2).

TABLE 1
s₀ = XOR(r₃₈,r₃₇,r₃₆,r₃₅,r₃₄,r₃₁,r₂₈,r₂₅,r₂₄,r₂₃,r₂₁,r₁₉,r₁₈,r₁₄,r₁₂,r₀);
s₁ = XOR(r₃₈,r₃₇,r₃₆,r₃₅,r₃₂,r₂₉,r₂₆,r₂₅,r₂₄,r₂₂,r₂₀,r₁₉,r₁₅,r₁₃,r₁);
s₂ = XOR(r₃₈,r₃₇,r₃₆,r₃₃,r₃₀,r₂₇,r₂₆,r₂₅,r₂₃,r₂₁,r₂₀,r₁₆,r₁₄,r₂);
s₃ = XOR(r₃₆,r₃₅,r₂₇,r₂₆,r₂₅,r₂₃,r₂₂,r₁₉,r₁₈,r₁₇,r₁₅,r₁₄,r₁₂,r₃);
s₄ = XOR(r₃₈,r₃₅,r₃₄,r₃₁,r₂₇,r₂₆,r₂₅,r₂₁,r₂₀,r₁₆,r₁₅,r₁₄,r₁₃,r₁₂,r₄);
s₅ = XOR(r₃₈,r₃₇,r₃₄,r₃₂,r₃₁,r₂₇,r₂₆,r₂₅,r₂₄,r₂₃,r₂₂,r₁₉,r₁₈,r₁₇,r₁₆,r₁₅,r₁₃,
r₁₂,r₅);
s₆ = XOR(r₃₈,r₃₅,r₃₃,r₃₂,r₂₈,r₂₇,r₂₆,r₂₅,r₂₄,r₂₃,r₂₀,r₁₉,r₁₈,r₁₇,r₁₆,r₁₄,r₁₃,r₆);
s₇ = XOR(r₃₆,r₃₄,r₃₃,r₂₉,r₂₈,r₂₇,r₂₆,r₂₅,r₂₄,r₂₁,r₂₀,r₁₉,r₁₈,r₁₇,r₁₅,r₁₄,r₇);
s₈ = XOR(r₃₈,r₃₆,r₃₁,r₃₀,r₂₉,r₂₇,r₂₆,r₂₄,r₂₃,r₂₂,r₂₀,r₁₆,r₁₅,r₁₄,r₁₂,r₈);
s₉ = XOR(r₃₇,r₃₂,r₃₁,r₃₀,r₂₈,r₂₇,r₂₅,r₂₄,r₂₃,r₂₁,r₁₇,r₁₆,r₁₅,r₁₃,r₉);
s₁₀ = XOR(r₃₇,r₃₆,r₃₅,r₃₄,r₃₃,r₃₂,r₂₉,r₂₆,r₂₃,r₂₂,r₂₁,r₁₉,r₁₇,r₁₆,r₁₂,r₁₀);
s₁₁ = XOR(r₃₈,r₃₇,r₃₆,r₃₅,r₃₄,r₃₃,r₃₀,r₂₇,r₂₄,r₂₃,r₂₂,r₂₀,r₁₈,r₁₇,r₁₃,r₁₁);

Where sₙ denotes the n-th bit of the syndrome, rₘ denotes the m-th bit of the received 39-bit GEM head data. The function of XOR(a,b, . . . ) means an Exclusive-OR of all terms in the parentheses. Note that r₃₈ is received first in time and r₀ is received last in time.

The syndrome, for example, can be serially computed or parallel computed. Serial computing algorithm may use a set of shift registers with feedback logics, which may take multiple clock cycles to generate a syndrome. The parallel computing algorithm using equations illustrated in Table 1 can generate a syndrome within one step of combinatorial logic.

Hash component 305 further includes a hash circuit 306, a key circuit 308, a weight circuit 310, a memory circuit 312, a search circuit 314, a comparison circuit 316, and a vector circuit 318. Various connections 322-330 are used to interconnect circuits 304-320. A function of hash component 305 is to correct one or two bit errors. Another function of hash component 305 is to detect and report non-correctable errors. Circuit 320 is capable of correcting error bit(s) in the head data in response to the error vector(s) generated by circuit 318. If vector circuit 318 detects non-correctable errors, circuit 320 outputs the original received data packet.

Hash circuit 306, in one embodiment, generates a hash table and hashes a large number of syndromes into a smaller number of hash values. For example, hash circuit 306 is configured to perform a hash function, which hashes a table with a large number of entries 2^{x} to a table with a smaller number of entries 2^{y}, wherein x and y are integers in which y is smaller than x. If a syndrome is composed of a 12-bit field, hash circuit 306 is capable of reducing a table with 2¹² entries to a table with 2⁸ entries. In one embodiment, each entry of a hash table includes multiple subentries, wherein each subentry is capable of storing one or two error-correction locations. An exemplary hash function is illustrated in Table 2.

TABLE 2

h₀ = XOR(s₁₀,s₈,s₇,s₃);
h₁ = XOR(s₉,s₈,s₇,s₄,s₀);
h₂ = XOR(s₁₀,s₉,s₈,s₅,s₁);
h₃ = XOR(s₁₁,s₁₀,s₉,s₆,s₂);
h₄ = XOR(s₁₁,s₁₀, s₇,s₃);
h₅ = XOR(s₁₁,s₈,s₄);
h₆ = XOR(s₉,s₅);
h₇ = XOR(s₁₀,s₆);

Where hₙ is an n-th bit of a hash value, sₘ is an m-th bit of a syndrome.

A hash value may represent more than one syndrome value since different syndrome values can be resulted or calculated or hashed into a same hash value. Consequently, number of these syndromes determines number of subentries 460 needed in a hash entry 418. Hash circuit 306 using hash functions illustrated in Table 2 identifies a maximum number of syndromes for each entry of a hash table. In one embodiment, the maximum number of subentries 460-464 per entry 418 is five (5). For instance, each hash value points an entry, which includes five (5) subentries, in a hash table of a lookup memory. All syndromes derived from a received header with at least one error bit in the useful data field or head data can be hashed into a hash table having multiple entries, wherein each entry represents up to five (5) syndromes. As such, five sets of pre-calculated error-location numbers β₁ and β₂ of syndromes may have the same hash value and stored in the same entry in a hash table. It should be noted that each subentry further includes a 4-bit unique key value, which is used to address which one of the five subentries contains the correct error location(s). In one embodiment, each error location number is a five (5) bit field to address 27 bit locations.

It should be noted that any non-correctable syndrome has different combination of hash value and key value than the correctable syndromes. In other words, hash circuit 306 ensures that any correctable syndrome has a unique combination of hash value and key value. When weight value is greater than 2, hash values for all syndromes are computed and saved in a lookup memory. It should be further noted that the hash value may also be derived directly from the header using mathematically derived formulas.

Key circuit 308, in one embodiment, is capable of differentiating syndromes having the same hash value. Although syndromes stored in subentries of an entry have the same hash value, each subentry is associated with a unique key value. As such, key circuit 308 generates a key value, which identifies a syndrome from a subentry of a hash entry. Various key values for addressing syndromes are stored in memory entries or subentries in the hash table. It should be noted that key values can also be derived directly from the header using mathematically derived formulas. A search such as a binary search using a key value may be used to identify the error location number(s) in a subentry of a hash entry. An exemplary key function capable of generating key values in response to syndrome bits is illustrated in Table 3.

TABLE 3

key₀ = XOR(s₀,s₄,s₈);
key₁ = XOR(s₁,s₅,s₉);
key₂ = XOR(s₂,s₆,s₁₀);
key₃ = XOR(s₃,s₇,s₁₁);

where keyₙ is the n-th bit of the key value, sₘ is the m-th bit of the syndrome.

Weight circuit 310, in one embodiment, provides a weight value, which is used to indicate whether the error(s) is in the data field or in the HEC field. It should be noted that the occurrence of the bit error(s) in the HEC field may be harmless since it does not affect the data integrity of the head data. The head data, as described earlier, includes PLI, Port ID, and/or PTI.

In operation, weight circuit 310 generates a 4-bit numerical weight value in accordance with the syndrome. The weigh value, in one embodiment, indicates a total number of binary ones (is) found in the syndrome. Upon receipt of the syndrome, weight circuit 310 reads every bit in the syndrome. The weight value, for example, is computed by adding all twelve (12) bits of syndrome bits in an adder and the result is a 4-bit weight value. The weight value is subsequently forwarded to comparison circuit 316.

Comparison circuit 316, in one embodiment, determines whether correcting circuits can be bypassed. Correction logic or correcting circuits include hash circuit 306, key circuit 308, search circuit 314, and so forth. Upon receipt of the weight value, comparison circuit 316 compares the weight value with a set of integer value, such as 0, 1, 2, and the like. If, for example, the weight value is zero, it indicates that no error has occurred in the header during the transmission, and consequently, the correcting circuits can be bypassed. If the weight value is 1 or 2, it indicates that there is an error(s) in the HEC field, whereby no correction is necessary. If, however, the weight value is greater than 2, hash component 305 identifies whether the header includes a single-bit correctable error, a double-bit correctable error, or a non-correctable error. Since error does not usually occur frequently during a transmission, weight circuit 310 can enhance device performance by bypassing error correcting circuits when there is not error in the header data.

Memory 312, in one embodiment, includes a lookup memory, which is used to store a hash table in accordance with the hash value. For example, if a syndrome has a 12-bit field, a hash value with an 8-bit field should be generated. An 8-bit hash value indicates a hash table with 256 entries. Since each entry can represent up to five (5) syndromes, each entry is partitioned into five (5) subentries wherein each subentry includes a key field and error locations. If the correcting circuit is capable of correcting up to two (2) bits, the error locations should include a first error-location β₁ and a second error-location β₂. To identify an error bit location in a 27-bit field, an error-location number β needs 5 bits to identify the error bit position from one of the twenty-seven (27) possible bit locations.

Each subentry is, in one embodiment, 14 bits wide, bits [13:0], wherein bits [13:10] are used to store a key value. Bits [9:5] represent a number (β₁-13) if it is a valid first error-location number. Bits [4:0] represent a number (β₂-13) if it is a valid second error-location number. It should be noted that the first 13 bit-position of a header is used by the HEC field, which is not required to correct since it is not the head data. If the error location contains invalid data, a special code may be used, such as “0x1F”. It should be noted that lookup memory can be any types of memory, such as a RAM (random access memory), MRAM (magnetic RAM), or flash memory, ROM (read-only memory), and the like.

An empty subentry may also be indicated by a special code, such as “0x3FFF”. It should be noted that subentries of a hash entry are consecutively sorted base on the key values stored in them. If, for example, less than 5 subentries are required, they are placed close to the middle address first and the side subentries may not be used (empty). For a binary search method, hash circuit 306 stores the data in the subentries located in the middle first.

Search circuit 314, in one embodiment, is a binary search engine, which is capable of performing a binary search in the hash table to locate a designated subentry. Since the hash value is capable of identifying an entry from the hash table, search circuit 314 is used to identify which one of the five subentries contains the correct information. Depending on the latency of the lookup memory, the binary search can take between 3 to 5 clock cycles. If the memory read latency is one clock cycle or more, 5 subentries in 5 consecutive cycles can be read and subsequently, the subentries are buffered in registers. Similar binary search can be executed for the register read. It should be noted that number of memory read cycles can be as many as five (5). It should be further noted that search circuit 314 may perform other searching methods instead of binary search such as chronological search method. After finding of information relating to the error correction location(s), the information is forwarded to vector circuit 318.

Vector circuit 318, in one embodiment, processes error correction information in accordance with the information received from memory circuit 312, search circuit 314, and compare circuit 316. Alternatively, vector circuit 318, for example, instructs output circuit 320 to bypass the correcting circuits because syndrome bits are zero and no error has been found in the header. In one embodiment, vector circuit 318 generates an error vector, which includes a 27-bit binary vector indicating which one or two bits are the error bits. Vector circuit 318 also outputs a non-correctable error indicator if three (3) or more errors have been detected in the received header.

Output circuit 320 is configured to output an output header in response to the head data stored in buffer 302 and the error vector generated by vector circuit 318. In one embodiment, output circuit 320 receives head data from buffer 320 via connection 328 and corrects the head data in response to the error vector from vector circuit 318 via connection 330. For example, if the error vector provides bit-positions having one or two errors, output circuit 320 corrects the errors before it outputs the corrected header. If the error vector indicates no error, output circuit 320 outputs the head data stored in buffer 302 without any corrections. Alternatively, if the error vector indicates a three (3) or more errors, output circuit 320 outputs an error signal indicating uncorrectable errors have been detected. It should be noted that output circuit 320 may perform other functions, but there are not necessary to understand the exemplary embodiment of the present invention.

It should be noted that hash circuit 306, key circuit 308, and weight circuit 310 may perform their functions in parallel to enhance the overall device performance. It should be further noted that hash lookup device can reside in an optical component, such as an OLT, ONT, or the like.

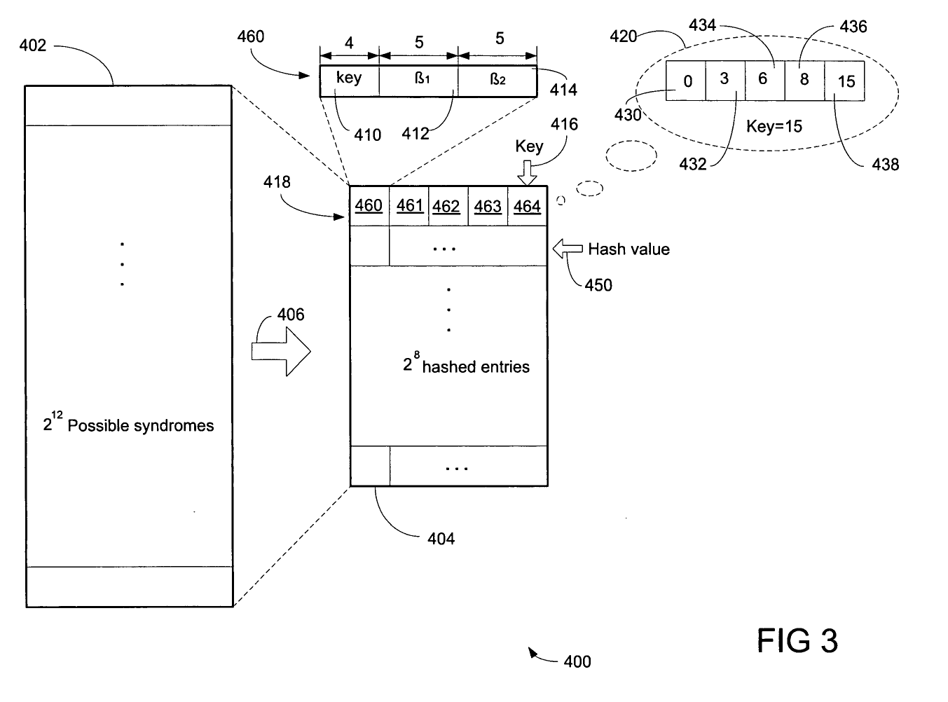

FIG. 3 illustrates an example of using a hash lookup device 400 in accordance with one embodiment of the present invention. Device 400 includes a syndrome circuit, which computes syndromes from received data. All possible syndromes are represented by space 402, wherein space 402 includes 2¹² (4096) syndromes. To store pre-calculated values for 12 bit syndromes, a table having 4096 entries would be required. It should be noted that the underlying concept of the embodiment does not change if one or more functional elements were added to or removed from device 400.

Hash table 404, in one embodiment, includes 2⁸ (256) entries wherein each entry is addressed by a hash value 450. Each entry further includes five (5) subentries 460-464 and each subentry includes a key 410 and two error location numbers β₁ and β₂ 412-414. Key 410, in one embodiment, is a 4-bit field and each error location number β is a 5-bit field. As discussed earlier, hash circuit 306 hashes space 402 with 4096 syndromes into hash table 404 with 256 entries. Also, five syndromes can be hashed into a single entry of hash table 404 wherein each entry has five partitions (or subentries) to accommodate up to five syndromes. It should be noted that 12-bit syndrome is an arbitrary number. It can be any number of bits for a syndrome.

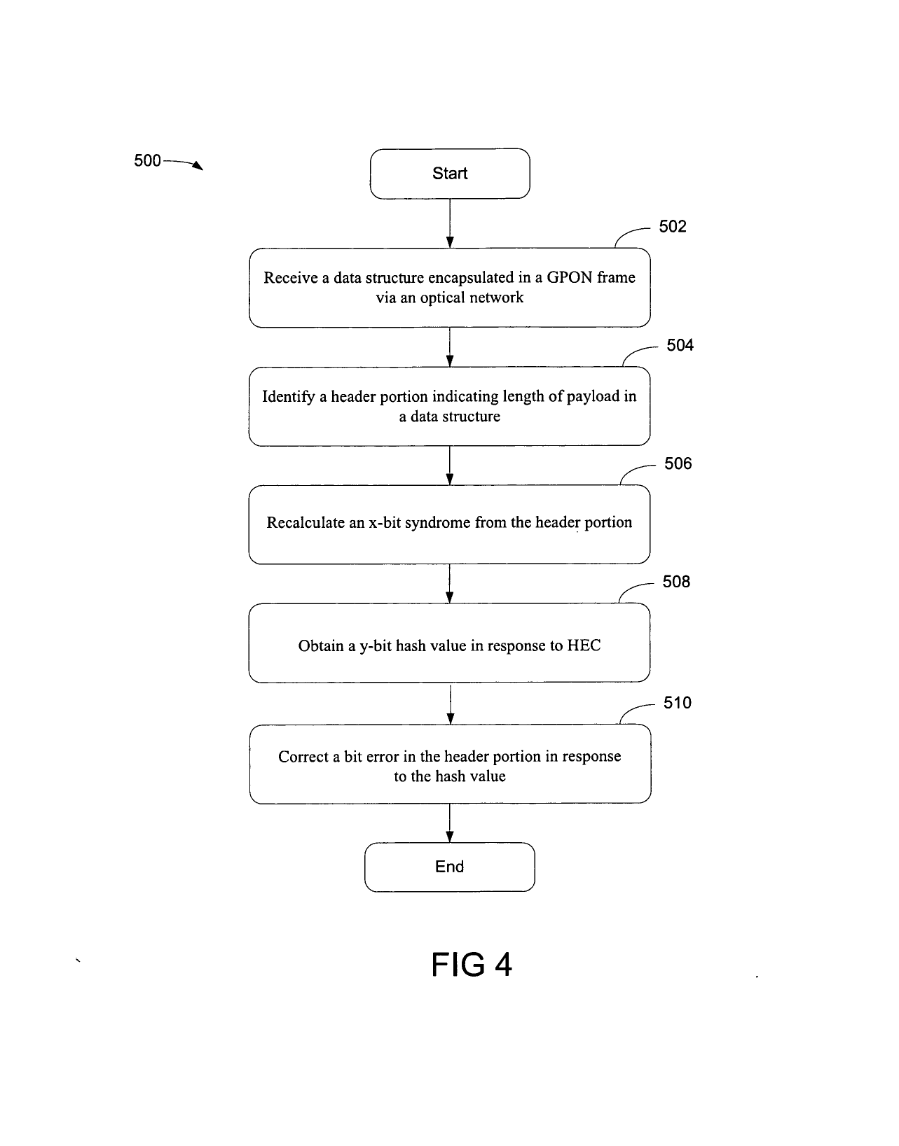

FIG. 3 also illustrates an example 420, which shows subentries 430-438 wherein subentries 430-438 includes key values β, 3, 6, 8, 15, respectively. If it is a 12-bit syndrome and the key is 15, device 400 computes the hash value of that syndrome and address of entry 418, and employs a binary search and checks the subentry 434 first to look for the key value. Since subentry 434 has a value of six (6), the binary search will search the next key value in the subentry to the higher value side (436). Since subentry 436 is not the right subentry, it further searches the higher value side (438) from subentry 436. When hash lookup device matches key value at subentry 438 as the key value 15, the correction location numbers β₁ and β₂ are fetched at subentry 438, not shown in FIG. 4. Error vectors are subsequently generated in according with β₁ and β₂.

During an operation, upon receipt of a GEM, a syndrome is computed from the received header. If the syndrome is zero, the received header is error free. Otherwise the received header bits need to be decoded. Head data decoding includes error detection and error correction. Different methods can be used to decode BCH code. After a search, either a subentry is found or no entry is found in hash table 404. If no entry is found, the error, for example, is not correctable. If an entry is found, the error-location numbers β₁ and β₂ from the entry are obtained, and then an error vector or an error correction vector is converted. The error vector is used to correct errors in the received header. Each of the error location numbers β₁ and β₂, in one embodiment, has 28 possible values. It should be noted that an error location number β could be one of the bit numbers from 13 to 39. Alternatively, error location number β may be an absent indicator. For example, if a syndrome is from a single bit error, β₁ will has a valid bit number indicator while β₂ will be an absent indicator. If a syndrome is from a non-correctable error (3 or more bit errors), both β₁ and β₂ are absent indicators. In one embodiment, the lookup memory entry is 14-bit wide. The total memory size is 256×5×14=17920 bits.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

The exemplary embodiment of the present invention can also be used to protect data integrity for other applications such as data processes and/or data storage. In one embodiment, hash lookup device 400 may be used to protect data from data corruption occurred during data storage at any type of storage media. For example, bit error may be introduced during a process of data storage at a storage media, and upon retrieving the data from the media, device 400 may be activated to correct bit error(s) using syndrome values and hash values.

FIG. 4 is a flowchart 500 illustrating an error correcting process using a hash function in accordance with one embodiment of the present invention. At block 502, the process of a hash lookup device receives a data structure encapsulated in a gigabit passive optical network (“GPON”) frame via an optical network. In one embodiment, the process is capable of identifying a data structure of GEM. After block 502, the process proceeds to the next block.

At block 504, the process identifies a header portion and a payload portion wherein the header portion indicates the length of payload of data. In one embodiment, the process is further capable of identifying various fields in the header, such as PLI, ID ports, PTI, and HEC. After block 504, the process proceeds to the next block.

At block 506, the process recalculates a syndrome from received header, herein referred to as a syndrome, and extracts the parity bit from HEC. In one embodiment, the syndrome portion includes an x-bit field while the parity portion includes a p-bit field. For example, x may be 12 and p may be 1. The process, in one embodiment, is further capable of using syndromes coded in BCH to improve head data integrity. After block 506, the process proceeds to the next block.

At block 508, the process obtains a y-bit hash value in response to the HEC, wherein y, in one embodiment, is a smaller integer value than x. For example, if x is twelve (12), y may be eight (8). The process calculates an 8-bit hash value in accordance with a 12-bit syndrome in the HEC. It should be noted that a hash table is generated in accordance with the hash value. After block 508, the process moves to the next block.

At block 510, the process corrects a bit error in the header portion in response to the hash value. In one embodiment, the process further calculates a z-bit key value in accordance with syndrome and corrects one error or two errors in the head data in accordance with the hash value and the key value. For example, a 4-bit key value is calculated in accordance with the syndrome. The process, in one embodiment, further calculates a w-bit weight value in accordance with the syndrome and correcting the bit error in the header portion in response to the hash value and the key value and the weight value. It should be noted that both w and z are small integer values and they are smaller than y. For instance, a 4-bit weight value may be obtained in accordance with the syndrome. In one embodiment, the hash value, the key value, and the weight value can be calculated in parallel. Alternatively, the hash value, the key value and the weight value can begin to be calculated at the substantially same clock cycle. The process uses the weight value to indicate no error or errors in the HEC field. Upon detecting a correctable error, an entry from a lookup memory is fetched in accordance with the hash value. The process, in one embodiment, uses the binary search method to locate one or two pre-calculated error location numbers in a subentry in response to the key value. An error vector is subsequently generated in response to the pre-calculated error location number(s). It should be noted that a header portion of a GEM may be 40 bits wide. After block 510, the process ends.

While particular embodiments of the present invention have been shown and described, it will be obvious to those skilled in the art that, based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method for data transmission comprising:
receiving a data structure encapsulated in a gigabit passive optical network (“GPON”) frame via an optical network;
identifying a header portion indicating length of payload of data carried by the data structure;
recalculating an x-bit syndrome from the header portion;
obtaining a y-bit hash value in response to the x-bit syndrome, wherein y is a smaller integer than x; and
correcting a bit error in the header portion in response to the hash value.

2. The method of claim 1, further comprising:
calculating a z-bit key value in accordance with the x-bit syndrome, wherein z is smaller than y; and
correcting the bit error in the header portion in response to the hash value and the key value.

3. The method of claim 2, further comprising:
calculating a w-bit weight value in accordance with the x-bit syndrome, wherein w is a smaller integer than y; and
correcting the bit error in the header portion in response to the hash value and the key value and the weight value.

4. The method of claim 3, wherein correcting the bit error in the header portion in response to the hash result and the key value and the weight value further includes:
identifying the header data containing at least one error or error free in response to the weight value; and
fetching an entry from a lookup memory in accordance with the hash value.

5. The method of claim 4, wherein correcting the bit error in the header portion in response to the hash result and the key value and the weight value further includes:
searching a pre-calculated error location number in a subentry in response to the key value; and
generating an error vector in response to the pre-calculated error location number.

6. The method of claim 5, wherein searching a pre-calculated error location number in an subentry in response to the key value includes utilizing a binary search to locate one of five pre-calculated error location numbers in the entry.

7. The method of claim 3, wherein identifying a header portion further includes identifying a GPON Encapsulation Method (“GEM”) having a 40-bit header.

8. The method of claim 7,
wherein determining the x-bit syndrome calculated from the header portion includes identifying a 12-bit syndrome;
wherein obtaining a y-bit hash value includes calculating an 8-bit hash value in accordance with the 12-bit syndrome;
wherein calculating a z-bit key value further includes obtaining a 4-bit key value in accordance with the 12-bit syndrome; and
wherein calculating a w-bit weight value further includes obtaining a 4-bit weight value in accordance with the 12-bit syndrome.

9. The method of claim 8, wherein obtaining the 8-bit hash value, the 4-bit key value, and the 4-bit weight value further includes beginning to calculating the 8-bit hash value, the 4-bit key value, and the 4-bit weight value at the substantially same clock cycle.

10. The method of claim 9, wherein recalculating an x-bit syndrome from the header portion further includes identifying the syndrome coded by Bose, Chaudhuri, and Hocquengham (“BCH”) codes.

11. A device for data communication, comprising:
a first circuit capable of performing a hash function, and configured to generate a hash value in response to a value of recalculated syndrome;
a second circuit coupled to the first circuit and capable of obtaining a data entry from a lookup table in a memory in accordance with the hash value;
a third circuit coupled to the second circuit and capable of generating an error vector in response to the data entry; and
a fourth circuit coupled to the third circuit and configured to correct an error in a header portion of a data structure encapsulated in the GPON frame.

12. The device of claim 11,
wherein the first circuit is a hash logic capable of converting a 12-bit syndrome coded in Bose, Chaudhuri, and Hocquengham (“BCH”) to an 8-bit hash value; and
wherein the data structure is configured to a GPON Encapsulation Method (“GEM”), wherein GEM includes a 40-bit header.

13. The device of claim 12, wherein the header of the GEM includes a payload length portion, a destination, a payload type indicator, and the HEC.

14. The device of claim 12, further includes:
a key logic coupled to the hash logic and configured to generate a key value; and
a search logic coupled to the key logic and configured to identify an error-location number in the data entry in accordance with the key value.

15. The device of claim 14, further includes:
a weight logic coupled to the syndrome logic and configured to generate a weight value; and
a weight compare logic coupled to the weight logic and capable of detecting an error in the data structure.

16. The device of claim 15, wherein the error vector includes information indicating one of one error, two errors, and three or more errors.

17. The device of claim 14, wherein the second circuit coupled to the first circuit and capable of obtaining a data entry from a lookup table in a memory further identifies one of five subentries in the data entry in accordance with the key value.

18. The device of claim 17, wherein the a fourth circuit is a correcting logic capable of correcting a single error or double errors, wherein the correcting logic is further capable of reporting more than two errors in the header.

19. The device of claim 15, wherein the hash logic, the key logic, and the weight logic begin to perform their functions substantially same clock cycle.

20. An optical component configured to transmit data encapsulated in the GPON frames in an optical network comprising the device of claim 11.

21. A data storage system capable of storing information to a storage media and retrieving information from the storage media comprising the device of claim 11.

22. An apparatus for data transmission comprising:
means for receiving a data structure encapsulated in a gigabit passive optical network (“GPON”) frame via an optical network;
means for identifying a header portion indicating length of payload of data carried by the data structure;
means for recalculating an x-bit syndrome from the header portion;
means for obtaining a y-bit hash value in response to the x-bit syndrome, wherein y is a smaller integer than x; and
means for correcting a bit error in the header portion in response to the hash value.

23. The apparatus of claim 22, further comprising:
means for calculating a z-bit key value in accordance with the x-bit syndrome, wherein z is smaller than y; and
means for correcting the bit error in the header portion in response to the hash value and the key value.

24. The apparatus of claim 23, further comprising:
means for calculating a w-bit weight value in accordance with the x-bit syndrome, wherein w is a smaller integer than y; and
means for correcting the bit error in the header portion in response to the hash value and the key value and the weight value.

25. The apparatus of claim 24, wherein means for correcting the bit error in the header portion in response to the hash result and the key value and the weight value further includes:
means for identifying one of correctable data error and zero bit error in response to the weight value; and
means for fetching an entry from a lookup memory in accordance with the hash value.

26. The apparatus of claim 25, wherein means for correcting the bit error in the header portion in response to the hash result and the key value and the weight value further includes:
means for searching a pre-calculated error location number in a subentry in response to the key value; and
means for generating an error vector in response to the pre-calculated error location number.

27. A device for enhancing data integrity, comprising:
a syndrome logic configured to generate 12-bit syndromes in Bose, Chaudhuri, and Hocquengham (“BCH”) (63, 12, 2) code in accordance with 40-bit head data;
a hash circuit coupled to the syndrome logic and configured to hash the 12-bit syndrome into an 8-bit hash value with a property of 0 to 5 different syndrome values;
a key circuit coupled to the syndrome logic and capable of mapping 12-bit syndromes into 4-bit key values, wherein each syndrome value has a unique 4-bit key value within all syndromes that have same hash value; and
a vector circuit coupled to the key circuit and configured to identify non-correctable errors from the syndrome in response to the hash value and the key value.
